(19) United States
(12) Patent Application Publication
(10) Pub. No.: US 2026/0040011 A1
(43) Pub. Date: Feb. 5, 2026

(54) HEARING EXCITATION SYSTEM AND METHOD FOR OPERATING A HEARING EXCITATION SYSTEM

(71) Applicants: Medizinisches Laserzentrum Lübeck GmbH, Lübeck (DE); Deutsches Hörgeräte Institut GmbH, Lübeck (DE)

(72) Inventors: Ralf Brinkmann, Lübeck (DE); Christin Grill, Lübeck (DE); Hendrik Husstedt, Lübeck (DE); Florian Denk, Lübeck (DE)

(21) Appl. No.: 19/288,295

(22) Filed: Aug. 1, 2025

(30) Foreign Application Priority Data
Aug. 2, 2024 (EP) 24192598.1

(51) Int. Cl. H04R 23/00; H04R 25/00

(52) U.S. Cl. CPC H04R 23/008; H04R 25/606

(57) ABSTRACT

Hearing excitation system for an eardrum (16), comprising a signal generator (17) and an optomechanical transducer (18) for exciting a vibration of an eardrum (16). The signal generator (17) is designed to emit a light signal (20) such that the light signal (20) hits the optomechanical transducer (18) and the light signal (20) triggers thermal deformation in the optomechanical transducer (18). The optomechanical transducer (18) is designed such that the thermal deformation causes a change in the curvature of the optomechanical transducer (18), as a result of which a surface portion (30, 31) of the optomechanical transducer (18) is deflected. The invention also relates to a method for operating a hearing excitation system.

### BACKGROUND

The invention relates to a hearing excitation system and to a method for operating a hearing excitation system.

Hearing aids are devices which are worn on or in the ear and are intended to be used to compensate for a reduced hearing ability as well as possible. For this purpose, a sound transducer is excited such that a sound signal present in the environment is transmitted in a suitable form to the eardrum and is fed into the auditory pathway. Success in using a hearing aid also depends on the quality with which the processed sound is played back to the auditory pathway. Due to physical limitations of the playback technology, the performance of current hearing aids is often not yet satisfactory despite major advances in signal processing. For optimal care of people with impaired hearing, it is desirable that the entire audible frequency range (20 Hz to 20 kHz) can be amplified without the need to close the auditory canal.

Conventional hearing aids use miniature loudspeakers according to the electromagnetic principle as sound transducers. With these sound transducers, the playback range is limited by design to a maximum of approximately 8 kHz, but often only values up to 5 kHz are achieved when high amplifications are required. In the frequency range below 1 kHz, it is also necessary to close the auditory canal in order to be able to play back sound at a sufficient level. This greatly reduces the wearing comfort of the hearing aid and increases the risk of infections in the auditory canal.

Active eardrum contact transducers are known as an alternative to miniature loudspeakers, EP 3 794 843 A1, US 2023/0080201 A1. These are electro-mechanically driven vibrators that are in contact with the eardrum and directly cause the auditory pathway to vibrate mechanically. This enables a playback bandwidth that is higher than conventional hearing aids and approximately covers the audible frequency range. This requires an electromechanical component on the eardrum, which is controlled inductively, optically or via a cable, depending on the design. This limits the practicability and long-term stability of the approach.

Optical stimulation of the auditory pathway at various points is also prior art. Direct neural stimulation of the hair cells or the auditory nerve with laser light was thus demonstrated, M. Jeschke and T. Moser, “Considering optogenetic stimulation for cochlear implants”, Hear. Res., vol. 322, pp. 224-234, April 2015, doi: 10.1016/j.heares.2015.01.005. However, such stimulation is only conceivable in connection with cochlear implants.

The possibility of optoacoustic excitation of the ear, i.e. the generation of acoustic or mechanical vibrations by exposure to laser light at various points of the auditory pathway, was also described, U.S. Pat. No. 8,545,383 B2. This type of stimulation was demonstrated both at implant-accessible positions such as inside the cochlea or at the round window of the cochlea in the middle ear, and by irradiating the eardrum with laser light of various colors. It was also shown here that the efficiency of optoacoustic excitation can be increased when irradiating the eardrum if a three-layer element is placed on the eardrum, US 2022/0395695 A1, K. Sorg et al., “Optoacoustically induced auditory brainstem responses in the mouse model enhanced through an absorbing film”, J. Biomed. Opt., vol. 26, no. 09, September 2021, doi: 10.1117/1.JBO.26.9.09800.

### SUMMARY

The invention is based on the object of presenting a hearing excitation system and a method for operating a hearing excitation system which reduce the disadvantages mentioned. Proceeding from the above-mentioned prior art, the object is achieved with the features of the independent claims. Advantageous embodiments are specified in the dependent claims.

A hearing excitation system according to the invention for an eardrum comprises a signal generator and an optomechanical transducer. The optomechanical transducer is designed to excite vibrations of the eardrum. The signal generator is designed to emit a light signal such that the light signal hits the optomechanical transducer and the light signal triggers thermal deformation in the optomechanical transducer. The optomechanical transducer is designed such that the thermal deformation causes a change in the curvature of the optomechanical transducer, as a result of which a surface portion of the optomechanical transducer is deflected.

The term light signal is not associated with any restriction to the wavelength range of visible light. The term light signal includes electromagnetic waves with wavelengths in the ultraviolet spectral range and electromagnetic waves with wavelengths in the infrared spectral range. In particular, electromagnetic waves with wavelengths between 200 nm and 20 μm, preferably between 700 nm and 12 μm, are included.

The optomechanical transducer is a passive element in which the thermal deformation according to the invention is triggered by the incident light signal. The optomechanical transducer thus differs from the electromechanically actuated contact transducers from the prior art. If the curvature of the optomechanical transducer according to the invention is changed, the radius of curvature on the front and/or on the back of the optomechanical transducer changes. An optomechanical transducer that is flat in the initial state can be transformed into a curved state by the thermal deformation. In the case of an optomechanical transducer that has a curved shape in the initial state, the curvature may be more pronounced or less pronounced after the thermal deformation.

A hearing excitation system according to the invention can be used as a hearing aid or for playing back other types of sound signals, such as sound signals from audio devices.

The invention is based on the fact that vibrations of the eardrum can be excited particularly effectively when the excitation is carried out by way of an optomechanical transducer. Compared to conventional hearing aids, in which the eardrum is excited by air vibrations that propagate between a loudspeaker and the eardrum, when excited by an optomechanical transducer, a larger frequency range is accessible, within which the eardrum can be excited with an open auditory canal. In the hearing excitation system according to the invention, the eardrum is therefore not excited by a loudspeaker, but by an optomechanical transducer.

The optomechanical transducer arranged on the eardrum can be mechanically coupled to the eardrum of the supported ear when using the hearing excitation system. This coupling can take place in a two-dimensional manner or at points, e.g. at the umbo (Sunil Puria, Peter Luke Santa Maria, Rodney Perkins Otology & Neurotology, “Temporal-Bone Measurements of the Maximum Equivalent Pressure Output and Maximum Stable Gain of a Light-Driven Hearing System that Mechanically Stimulates the Umbo”, issue 37, pages 160-166, 2016). Alternatively, it is also possible for the optomechanical transducer arranged on the eardrum to not be in direct mechanical contact with the eardrum, but for the excitation to be effected by a gas volume enclosed between the optomechanical transducer and the eardrum. In particular, the gas volume can be an air volume.

The optomechanical transducer is excited with light signals. The light signal is used to transfer energy to the optomechanical transducer, which leads to preferably inhomogeneous heating of the optomechanical transducer and thus to thermal deformation. The optomechanical transducer is designed such that the thermal deformation leads to a change in the curvature of the optomechanical transducer and, as a result of the change in the curvature, leads to a surface portion of the optomechanical transducer being deflected. Due to the coupling of the optomechanical transducer to the eardrum, the deflection of the optomechanical transducer is transferred into a deflection of the eardrum.

When the light signal is interrupted, the inhomogeneous temperature distribution is equalized, with the result that the force effect generated by the inhomogeneous thermal expansion, and the change in curvature caused thereby, also decreases again and relaxation occurs. A desired vibration of the eardrum can be excited by alternating thermal expansion and relaxation of the optomechanical transducer. For example, the amplitude of the deflection can be between 1 μm and 10 μm, corresponding to the deflection of the eardrum for the audible range (Cheng, et al. J. Acoust. Soc. Am. Vol. 133 Issue 2, pp. 918-937). The heat introduced into the optomechanical transducer during this excitation is continuously dissipated to the environment. In the operating state, a balance of introduced heat and dissipated heat is achieved, which can result in a slight increase in the mean temperature of the optomechanical transducer.

The optomechanical transducer can be a prefabricated component intended to be arranged on the eardrum of a supported ear. The optomechanical transducer can be positioned in the auditory canal in such a way that there is mechanical coupling to the eardrum. The mechanical coupling can result from the optomechanical transducer resting directly on the eardrum. A coupling substance between the optomechanical transducer and the eardrum is also possible. The coupling substance can be used to form an adhesion layer between the optomechanical transducer and the eardrum. The adhesion layer can be used to form a connection between a back of the optomechanical transducer and the eardrum. In one embodiment, the coupling substance is an adhesive which is used to attach the optomechanical transducer to the eardrum. A coupling substance that creates coupling between the optomechanical transducer and the eardrum in a liquid state is also possible. For example, the optomechanical transducer can be coupled to the eardrum by a drop of oil. If the oil is of a suitable viscosity, deflections of the optomechanical transducer are transferred to the eardrum via the oil. Depending on the structure of the optomechanical transducer, the coupling layer can also be in the form of a thermally highly conductive or thermally highly insulating layer.

Alternatively, the optomechanical transducer can be arranged in the auditory canal in such a way that a gas volume is enclosed between the optomechanical transducer and the eardrum. The gas volume should be so small that the deflections of the optomechanical transducer are effectively transferred to the eardrum. The distance between the optomechanical transducer should be small, for example less than 5 mm, preferably less than 2 mm, further preferably less than 1 mm. The optomechanical transducer can be formed by a membrane that is air-permeable. This means that, on the one hand, the volume between the optomechanical transducer and the eardrum is closed so tightly that it is possible to effectively transfer pressure for exciting the vibration of the eardrum. On the other hand, air exchange through the breathable membrane is made possible in order to keep the humidity and thus the risk of bacterial or mycotic inflammations low.

The optomechanical transducer may be a component of a hearing device, wherein the hearing device comprises a frame supporting the optomechanical transducer and the signal generator. The element from which the light signal exits in the direction of the optomechanical transducer is referred to as the signal generator. The actual light source, i.e. for example a laser diode or LED, which generates the light signal, can be arranged separately from the frame. The light signal can be transmitted between the light source and the signal generator via a light guide. The hearing device may include a spacer in order to set a defined distance between the optomechanical transducer and the eardrum. The spacer may be connected to the frame. The spacer may be annular and may be designed such that the eardrum is not touched centrally. The hearing device can be designed such that the user themself can insert the hearing device into their own ear. The hearing device can be designed such that it has a fixed position within the auditory canal when used. The fixed position can result, for example, from contact with a wall of the auditory canal.

The invention also includes embodiments in which the optomechanical transducer is not a prefabricated part, but a structure applied to the eardrum as a coating. For example, the optomechanical transducer can be produced by applying a layer of liquid or pasty material to the eardrum and by curing the material to form a layer with appropriate mechanical properties.

The optomechanical transducer may have a geometric shape that has a small thickness compared to the areal extent. The thickness may be less than 500 μm, preferably less than 300 μm. Prefabricated components are usually thicker than 20 μm. In particular, an optomechanical transducer in the form of a coating may also be thinner than 20 μm. If the optomechanical transducer has a circular contour line surrounding the area, the diameter of the circular contour may be greater than the thickness of the optomechanical transducer by at least a factor of 10, preferably a factor of 50, further preferably a factor of 200. If the optomechanical transducer has a variable thickness, the specification refers to the largest thickness of the optomechanical transducer. If the optomechanical transducer has a non-circular contour, the specification refers to the diameter of the largest circle within the contour. A plane within which the optomechanical transducer has its largest contour line or within which a projection of the largest contour line is located is referred to as the X-Y plane.

During use, the optomechanical transducer may be arranged such that the areal extent of the optomechanical transducer is aligned with the eardrum. The optomechanical transducer can have a shape that matches the eardrum. In one embodiment, the optomechanical transducer has a curved or conical shape. The curved or conical shape can match the topography of the eardrum. In the case of an optomechanical transducer whose largest contour extends in an X-Y plane, the deflection can take place in the Z direction. If the largest contour is not within a plane, the specification refers to a projection of the optomechanical transducer into a plane.

The thickness of the optomechanical transducer may extend between a front and a back of the optomechanical transducer. The back may be the side of the optomechanical transducer facing the eardrum, and the front may be the side of the optomechanical transducer facing away from the eardrum. The optomechanical transducer may have a flat surface forming the back and/or a flat surface forming the front.

The invention also includes embodiments in which neither the front nor the back is formed by a flat surface. In particular, the optomechanical transducer may have a curved or conical shape in the initial state. This shape can correspond to the anatomical shape of the eardrum, which is curved concavely in the direction of the middle ear.

The signal generator may be designed to emit the light signal in the form of modulated electromagnetic radiation directed at the surface of the optomechanical transducer. The wavelength of the electromagnetic radiation can be in particular in the wavelength range between 200 nm and 20 μm, preferably between 700 nm and 12 μm. The wavelength of the light to be used and the absorption of the optomechanical transducer can be matched to one another such that the light is ideally completely absorbed by the optomechanical transducer and the light energy is converted as efficiently as possible into a curvature of the surface.

When using the hearing excitation system according to the invention, the signal generator can be arranged in the auditory canal in such a way that the signal generator has a clear view of the optomechanical transducer, that is to say that the electromagnetic radiation can propagate in a straight line from the signal generator to the optomechanical transducer without the propagation path being blocked by tissue of the auditory canal. The signal generator may be designed such that it does not close the auditory canal. The signal generator may have a passage channel that allows air exchange through the signal generator and thus has good acoustic transmissivity. The signal generator, from which the light signal exits in the direction of the optomechanical transducer, can form a structural unit with the light source in which the electromagnetic radiation is generated. It is also possible for the signal generator and the light source to be separate units. The light signal can be transmitted between the light source and the signal generator via a light guide. The light source may be designed to be arranged outside the auditory canal, for example behind the auricle.

The signal generator can be designed in such a way that the light signal is applied to a flat section of the optomechanical transducer. That region on the front of the optomechanical transducer to which the light signal is applied may constitute at least 20%, preferably at least 40%, further preferably at least 60%, of the area on the front of the optomechanical transducer. The light signal can cover the entire area or part of the area of the optomechanical transducer; in particular, the light signal can illuminate the optomechanical transducer with substantially constant intensity. However, it is also possible to heat the area with a Gaussian or other beam profile, in particular depending on the chosen absorber distribution.

Also included are embodiments in which the illuminated region is not areally illuminated. For example, an annular light signal could be directed to the optomechanical transducer, which means that the light signal is not applied to the center of the illuminated region. In this case, the large-area section of the optomechanical transducer, to which the light signal is applied, corresponds to the outer circumference of the ring.

The light signal can be directed to the optomechanical transducer in the form of a series of light pulses. The temporal sequence of the light pulses may be designed such that the interruption between two light pulses is longer than the duration of the light pulse, preferably longer by at least a factor of 10, further preferably longer by at least a factor of 100, further preferably longer by at least a factor of 1000. The duration of the individual light pulses can preferably be shorter than the thermal confinement time in the optomechanical transducer. A shorter pulse duration than the acoustic confinement time in the optomechanical transducer can also be applied. If the light pulses do not have the same duration, the specification refers to the longest of the light pulses. The pause between two light pulses can serve as a relaxation time within which the optomechanical transducer can release heat absorbed with the preceding light pulse. A significant contribution to heat dissipation can be made by blood circulation near the optomechanical transducer. An insulating layer may be formed between the optomechanical transducer and the eardrum in order to prevent excessive heating of the eardrum. An area of the optomechanical transducer facing away from the eardrum can have a large roughness in order to promote heat release by convection.

Depending on the shape and design of the optomechanical transducer, an increase in the temperature of the optomechanical transducer of a few tenths of a degree Celsius may be sufficient to cause the desired deflection of the optomechanical transducer. However, temperature increases of a few degrees Celsius can also be acceptable. A temperature equilibrium, at which the amount of heat supplied with the light signal corresponds to the amount of heat released during the relaxation time, can be established, for example, if the length of the relaxation time is at least 5 μs, preferably at least 20 μs. Despite such a relaxation time, the frequency of the light pulses can be sufficiently high to enable the coding of a sound signal. A temperature equilibrium may be established over a multiplicity of light pulses, at which the tissue temperature in the vicinity of the optomechanical transducer is slightly higher than would be the case without the supplied light signals. The temperature remains in a range that is physiologically harmless.

The light signal may comprise a multiplicity of light pulses of equal length, which have equidistant time intervals to each other. The amplitude of the light pulses may vary. In particular, the amplitude of the light pulses can vary such that the light signal represents an audible sound signal by way of amplitude modulation. Other types of modulation can also be implemented, such as frequency modulation with unequal pulse spacings, or general pulse modulation with generally different pulse durations and shapes.

A sound signal in the vicinity of the hearing excitation system can be coded into the light signal. If the optomechanical transducer is excited with a light signal coded in this way, the desired hearing support is achieved by deflecting the optomechanical transducer at a frequency corresponding to the sound signal. The deflection of the optomechanical transducer is transferred to the eardrum.

For the functioning of the hearing excitation system, it is advantageous if the optomechanical transducer is designed in such a way that the energy of the incoming light signal is converted as efficiently as possible into a strong deflection of the optomechanical transducer perpendicular to the eardrum. A strong deformation of a homogeneous single-layer transducer can be achieved in particular by inducing an inhomogeneous temperature distribution in the optomechanical transducer, for example by heating the front region of the optomechanical transducer more strongly than the rear portion, or by heating the central region more strongly than the edge regions. The thermal deformation can cause a mechanical stress within the optomechanical transducer, which leads to a change in the geometric shape and thus to a deflection of the optomechanical transducer.

A good deflection of the optomechanical transducer can result if the optomechanical transducer is made of a plurality of materials, with a first material having a higher coefficient of thermal expansion than a second material. It is also possible, additionally or alternatively, for the optomechanical transducer to comprise a first material having a higher optical absorption coefficient or a lower thermal capacity than a second material of the optomechanical transducer.

The optomechanical transducer may comprise a first layer and a second layer, the first layer consisting of a material having a higher coefficient of thermal expansion than the material of the second layer. The first layer may be arranged on or near the front of the optomechanical transducer. The second layer may be arranged on or near the back of the optomechanical transducer. Each of the layers can extend over the entire area of the optomechanical transducer. When the light signal hits the optomechanical transducer, the first layer expands more than the second layer, and the optomechanical transducer deforms like a bimetal, with the result that the optomechanical transducer is deflected. The deflection relaxes before the next light pulse hits the optomechanical transducer.

In an alternative embodiment, a central region of the optomechanical transducer is configured differently from a peripheral region of the optomechanical transducer. In particular, the optomechanical transducer may be designed such that the peripheral region of the optomechanical transducer prevents the central region of the optomechanical transducer from being able to expand in the radial direction. For example, if a central region with a high coefficient of thermal expansion is surrounded by a peripheral region with a lower coefficient of thermal expansion, thermal expansion of the central region into the peripheral region is not possible. Rather, the thermal expansion transforms into a deflection of the central region. The peripheral region may extend annularly around the central region. Additionally or alternatively, the peripheral region may consist of a material that has a lower thermal conductivity than the material of the central region. This can also help to increase the deflection of the optomechanical transducer. Additionally or alternatively, the local light irradiation can be selected such that the central region heats up more than the peripheral region.

A high deflection of the optomechanical transducer can also be promoted by a suitable design of the surface of the optomechanical transducer, in particular by a suitable design of the front of the optomechanical transducer. This may involve, for example, forming a first region, which has a high absorption coefficient, on the surface and forming a second region, which has a lower absorption coefficient, on the surface. The absorption coefficient determines what proportion of the incident light signal is converted into heat. In regions with a higher absorption coefficient, the thermal expansion is more pronounced. The distribution of the surface regions can be selected in such a way that the resulting deflection is increased. In one embodiment, the region with a lower absorption coefficient corresponds to an annular region on the surface of the optomechanical transducer.

Additionally or alternatively, the local heat supply to the optomechanical transducer can also be influenced by the fact that the profile of the light signal, i.e. the distribution of the intensity over the cross section of the beam path, is adapted in a suitable manner. If, for example, a stop or an axicon is arranged in the beam path and hides a part of the beam path, other regions are defined in which a particularly large amount of heat is supplied to the optomechanical transducer. For example, a central region of the beam path can be hidden or used, which causes the light signal to illuminate or not illuminate an annular region on the surface of the optomechanical transducer. Alternatively, a Gaussian beam profile can also be selected, which irradiates the central region of the optomechanical transducer more strongly than the peripheral region.

The invention further relates to a method for operating a hearing excitation system, in which a light signal is directed to an optomechanical transducer coupled to an eardrum, such that the light signal triggers thermal deformation in the optomechanical transducer. The optomechanical transducer is designed such that the thermal deformation causes a change in the curvature of the optomechanical transducer. The change in the curvature excites a vibration of the eardrum.

The disclosure encompasses developments of the method comprising features that are described in the context of the hearing excitation system according to the invention. The invention encompasses developments of the hearing excitation system with features which are described in the context of the method according to the invention.

### BRIEF DESCRIPTION OF THE DRAWINGS

The invention is described by way of example below on the basis of advantageous embodiments with reference to the accompanying drawings, in which:

FIG. 1: shows a schematic representation of an auditory canal with a hearing excitation system according to the invention;

FIG. 2: shows a schematic representation of the functioning of a hearing excitation system according to the invention;

FIG. 3: shows a schematic representation of a light signal for exciting an optomechanical transducer of a hearing excitation system according to the invention;

FIG. 4: shows a schematic representation of an optomechanical transducer inserted into an auditory canal;

FIG. 5: shows a view of the front of the optomechanical transducer from FIG. 4;

FIG. 6: shows a sectional representation of the optomechanical transducer according to FIG. 5;

FIGS. 7-8: show the view according to FIGS. 5-6 in an alternative embodiment of the invention;

FIGS. 9-10: show the view according to FIGS. 5-6 in a further embodiment of the invention;

FIGS. 11-12: show the view according to FIGS. 5-6 in yet another embodiment of the invention;

FIGS. 13-14: show the view according to FIGS. 5-6 in yet another embodiment of the invention;

FIG. 15: shows an alternative embodiment of a signal generator according to the invention;

FIG. 16: shows the view according to FIG. 4 in a further embodiment of the invention;

FIGS. 17, 18: show a schematic representation of the functional principle of a hearing excitation system according to the invention;

FIGS. 19, 20: show a test setup for illustrating the functional principle according to the invention;

FIG. 21: shows three representations A, B, C of measured values recorded with the test setup from FIGS. 19, 20;

FIG. 22: shows a hearing excitation system according to the invention in the form of a hearing device.

### DETAILED DESCRIPTION

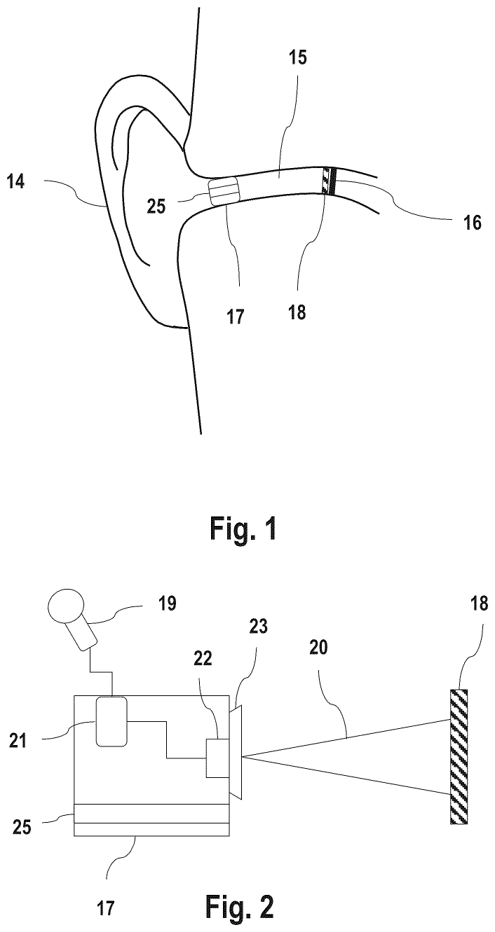

FIG. 1 illustrates a schematic representation of an auditory canal 15 of a human ear adjacent to an auricle 14. An eardrum 16 extends over the cross section of the auditory canal 15. Inserted into the auditory canal 15 is a hearing excitation system according to the invention which comprises a signal generator 17 and an optomechanical transducer 18. The optomechanical transducer 18 is arranged adjacent to the eardrum 16 and is mechanically coupled to the eardrum 16. The signal generator 17 is located in a section of the auditory canal 15 that lies between the eardrum 16 and the auricle 14. The signal generator 17 has a passage channel 25, such that free air exchange between the environment and that section of the auditory canal 15 which is arranged between the signal generator 17 and the optomechanical transducer 18 is possible.

According to FIG. 2, the signal generator 17 comprises an electromagnetic radiation source, for example in the form of an infrared light source 22, which emits a light signal 20.

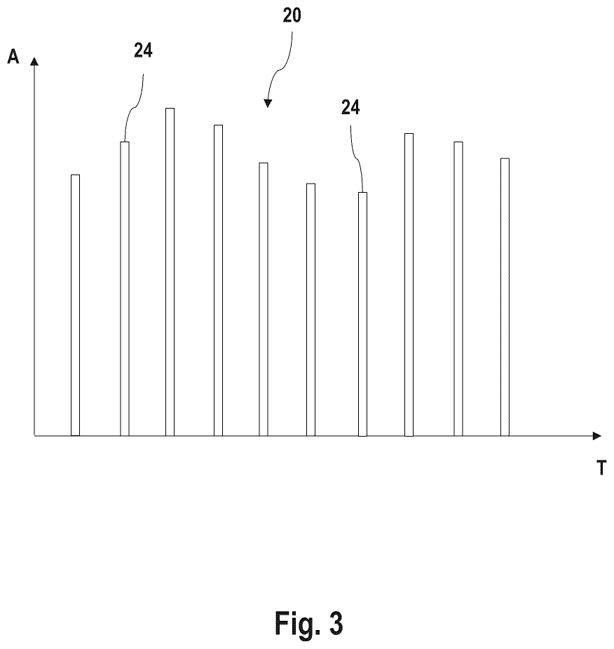

FIG. 3 schematically illustrates a light signal over the time T, which is generated by the infrared light source 22 based on the control signals received. The light signal 20 comprises a series of light pulses 24 which follow one another equidistantly in time. The frequency of the light pulses 24 may be, for example, of the order of magnitude of 40 kHz, with the length of a light pulse 24 being able to constitute the significantly smaller part of a period and the subsequent pause being able to constitute the significantly larger part of the period.

The infrared light source 22 is controlled in such a way that the sound signal is coded into the series of light pulses 24 by way of amplitude modulation. At a frequency of the light pulses of 40 kHz, it is possible to code sound signals in the audible range up to 20 kHz. The signal generator 17 is arranged in the auditory canal 15 such that the light signal 20 emitted by the signal generator 17 can propagate in the auditory canal 15 and hits the optomechanical transducer 18. The signal generator 17 comprises an exit optical unit 23 which is used to shape the light emitted by the infrared light source 22 into a desired beam shape, which is directed to the surface of the optomechanical transducer 18. In the exemplary embodiment according to FIG. 2, the beam path illuminates the surface of the optomechanical transducer 18 over a large area and with uniform brightness.

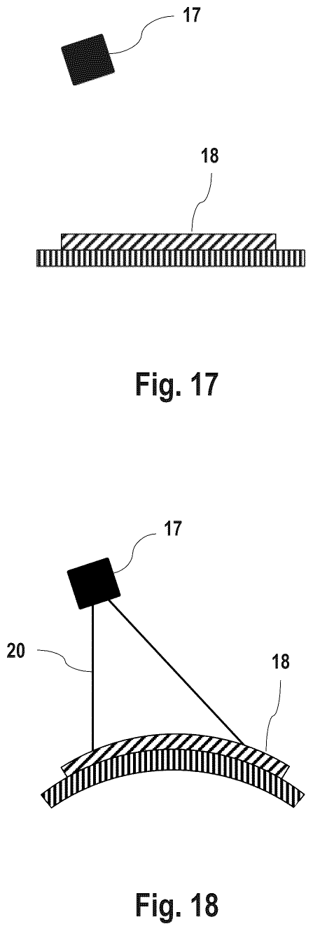

Each light pulse 24 that hits the optomechanical transducer 18 is ideally absorbed to a very large extent within the material of the optomechanical transducer 18, which is accompanied by a supply of thermal energy to the optomechanical transducer 18. The optomechanical transducer 18 is designed such that the amount of heat supplied causes a change in the curvature of the optomechanical transducer 18. In the illustrative example in FIGS. 17, 18, the optomechanical transducer 18 has a flat shape in the initial state in which no light signal 20 hits the optomechanical transducer 18. Under the influence of the amount of heat supplied with the light signal 20, the curvature of the optomechanical transducer 18 changes, with the result that it is deflected and changes into a curved shape, see FIG. 18. The deflections of the optomechanical transducer 18 are transferred to the eardrum 16 in order to excite vibrations of the eardrum 16.

In the exemplary embodiment according to FIGS. 2, 17, 18, the optomechanical transducer 18 consists of a homogeneous material which ideally has a high coefficient of thermal expansion and a low thermal capacity. The thermal energy supplied causes thermal deformation substantially in the region of the illuminated surface of the optomechanical transducer 18. Since the temperature increase is significantly smaller in the lower regions of the optomechanical transducer 18, the thermal deformation close to the surface causes the optomechanical transducer 18 to be deflected like a bimetal. However, the main difference to the bimetal is that the different thermal expansion is caused by inhomogeneous absorption of the light energy and not by the use of two materials with different coefficients of thermal expansion. The deflection is oriented substantially perpendicular to the plane of the optomechanical transducer 18. The plane of the optomechanical transducer 18 is referred to as the X-Y plane. The direction in which the deflection acts is the Z direction.

In the pause between two light pulses 24, the optomechanical transducer 18 releases heat to the environment. Part of the thermal energy is released convectively, and another part, in the case of contact application with respect to the eardrum, is also released via the blood circulation. An insulating layer may be formed between the optomechanical transducer 18 and the eardrum 16 in order to prevent excessive heating of the eardrum. The relaxation time between two light pulses 24 is sufficient for the optomechanical transducer 18 to return again substantially to its initial position, so that renewed excitation can be carried out with the subsequent light pulse. A high thermal conductivity and heat release of the optomechanical transducer is advantageous for this purpose. In sum, a temperature equilibrium is established over a multiplicity of light pulses 24, the temperature of which equilibrium is slightly increased compared to the temperature that would apply without the operation of the hearing excitation system.

The deflection can be small and, for example, can be of an order of magnitude of well below 10 μm. A small deflection is sufficient to excite the eardrum and provide hearing support.

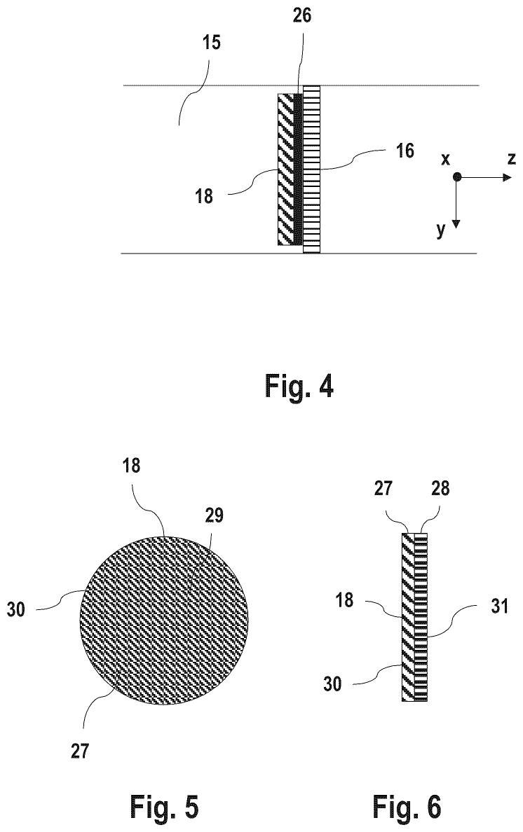

The optomechanical transducer 18 is mechanically coupled to the eardrum 16, with the result that the deflection of the optomechanical transducer 18 is transferred directly into a deflection of the eardrum 16. In the exemplary embodiment according to FIG. 4, the mechanical coupling results from the fact that the optomechanical transducer 18, which is a plate-shaped element, but which may also be pre-curved or adapted to the topography of the eardrum, is inserted into the auditory canal 15 and is coupled to the eardrum 16 via an adhesion layer 26. The adhesion layer 26 can be an oil film, for example. Other forms of adhesion layers are possible, such as an adhesive between the optomechanical transducer 18 and the eardrum 16, which is cured in contact with the eardrum 16.

FIGS. 5, 6 show an alternative embodiment of an optomechanical transducer 18, in which the body of the optomechanical transducer 18 is composed of a front layer 27 and a rear layer 28. The front layer 27 forms the front 30 of the optomechanical transducer 18 and has the light signal 20 applied to it. The mechanical coupling to the eardrum 16 is effected via the rear layer 28 which forms the back 31 of the optomechanical transducer 18. The front layer 27 consists of a material which has high optical absorption coefficients as well as a high coefficient of thermal expansion. The rear layer 28 can have a high thermal conductivity and adhere well to the eardrum if heat is to be efficiently dissipated into the bloodstream of the eardrum. Different materials are also possible in order to set the mechanical properties of the optomechanical transducer 18 in a desired manner. The materials can have different thermal conductivities, thermal capacities, densities, and mechanical stiffnesses. The thermal energy absorbed from a light pulse 24 results in a greater thermal expansion in the front layer 27 than in the rear layer 28, which in turn leads to a deflection of the optomechanical transducer 18 in the Z direction.

The front 30 of the optomechanical transducer 18 has a surface structure 29 that promotes absorption of the light pulses 24 and transfer of thermal energy to the optomechanical transducer 18. The surface structure 29, which is indicated in FIG. 5 by hatching, can have a high absorption for the wavelength of the light signal and a high roughness.

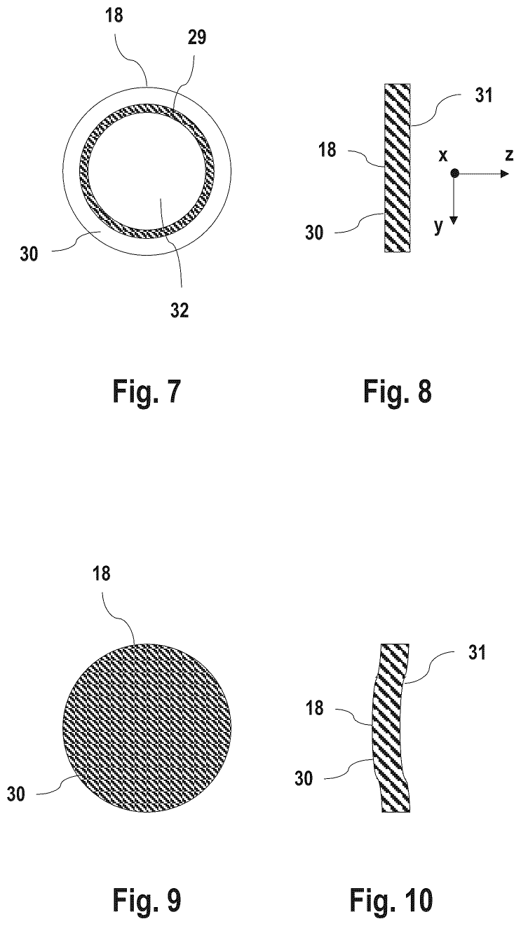

In the alternative embodiment according to FIGS. 7, 8, the front 30 of the optomechanical transducer 18 is divided into a first region 32, in which the surface has a high absorption coefficient, and a second region 29, in which less energy is absorbed. In the first region 32, the material of the optomechanical transducer 18 absorbs a large amount of thermal energy from a light pulse 24, as a result of which increased thermal deformation occurs locally. The shape of the first region 32 and of the second region 29 is chosen such that the thermal deformation is well converted into a deflection of the optomechanical transducer 18.

FIGS. 9, 10 show a further embodiment. According to FIG. 10, the optomechanical transducer 18 has a geometric shape which already has a curvature in the direction of the front 30 in the relaxed state.

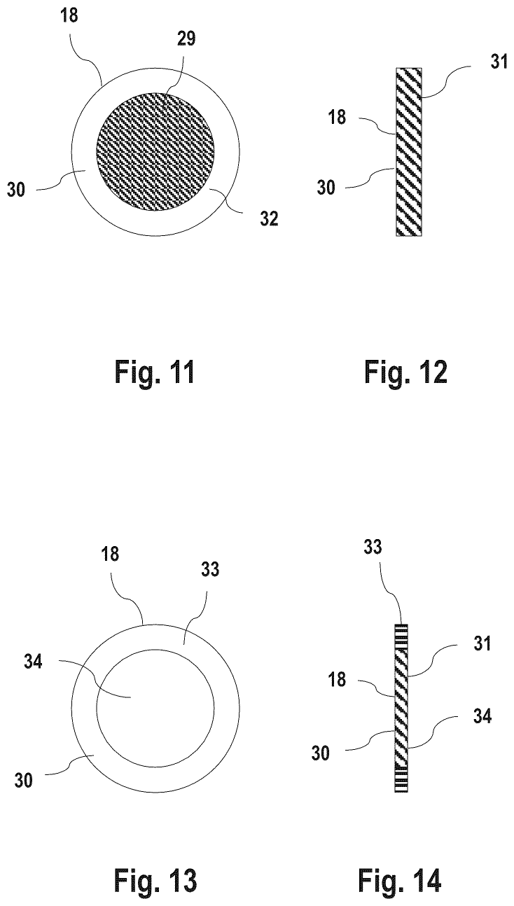

In the further embodiment in FIGS. 11, 12, the front 30 of the optomechanical transducer 18 has a first region 29 with a high absorption coefficient and a second region 32 with a low absorption coefficient. The first region 29 forms the center of the front 30, and the second region 32 extends annularly around the first region 29. The increased thermal deformation in the center of the optomechanical transducer 18 leads to a deflection in the Z direction.

FIGS. 13, 14 show a further embodiment in which the structure of the optomechanical transducer 18 has two parts. The periphery of the optomechanical transducer is formed by a ring 33. The ring 33 consists of a material with a small coefficient of thermal expansion. A disk 34 made of a material with a greater coefficient of thermal expansion is arranged in the interior of the ring 33. If the disk 34 heats up after a light pulse 24 hits, the ring 33 prevents expansion in the radial direction. Instead, the thermal expansion is converted into a deflection in the Z direction.

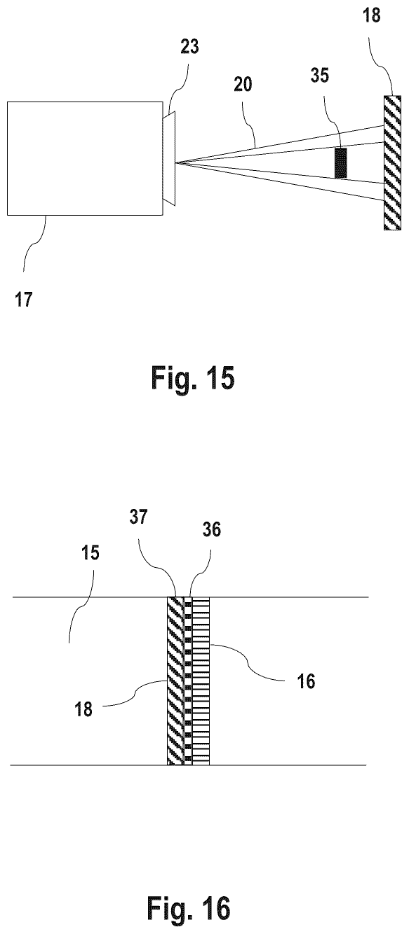

In the embodiment according to FIG. 15, a stop 35 is arranged in the beam path of the light signal 20 and hides an annular region of the beam path. In this way, infrared radiation is not applied to an annular region on the front of the optomechanical transducer 18, which, in a similar manner to that in FIGS. 7, 8, leads to a deflection in the Z direction.

In FIG. 16, the optomechanical transducer 18 is applied to the eardrum 16 in the form of a two-layer coating. The first layer 36 is applied or sprayed onto the eardrum 16 in a liquid state and cures there. After curing, the second layer 37 is applied to the first layer 36. The second layer 37 has a higher coefficient of thermal expansion than the first layer 36, with the result that a bimetal effect is established in a similar manner to that in FIG. 6 and the optomechanical transducer 18 is deflected in the Z direction when a light pulse 24 hits.

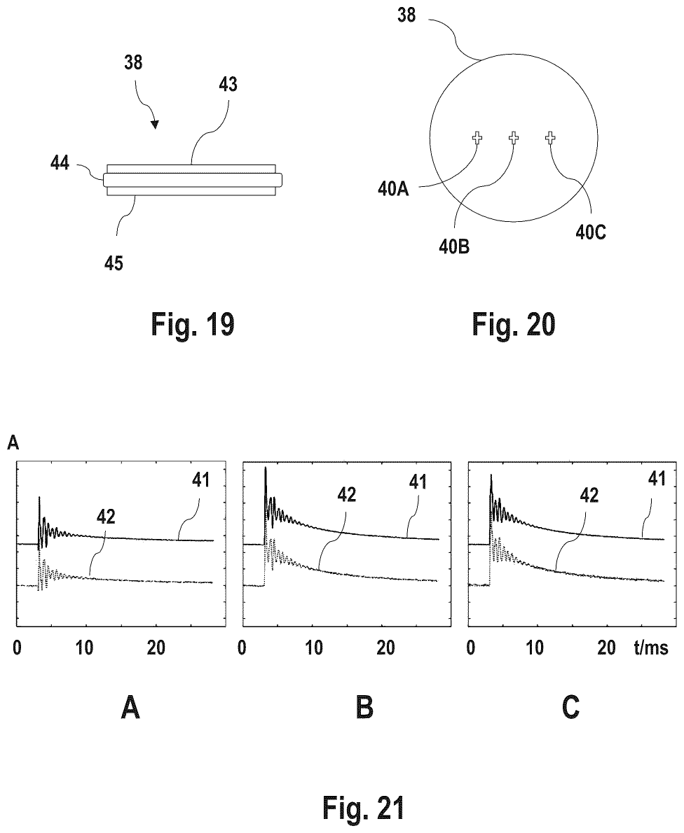

FIG. 19 shows a sample 38 which was used to demonstrate the functional principle according to the invention. The sample 38 comprises a membrane 45 made of a silicone material. The membrane 45 is used to simulate the eardrum of a supported ear. An optomechanical transducer 43 is coupled to the membrane 45 via an oil film 44. The membrane 45 was excited with a light signal in the form of a one-off light pulse. The deflection triggered by the excitation with the light signal was measured at three points 40A, 40B, 40C. FIGS. 20A, 20B, 20C illustrate the measured values for the measurement points 40A, 40B, 40C. Each curve corresponds to the deflection A over time, with the first curve 41 referring to the front of the sample 38 and the second curve 42 referring to the back of the sample 42, respectively. Thus, the first curve 41 corresponds to the vibration of the optomechanical transducer 43, and the second curve 42 corresponds to the vibration of the silicone membrane 45. The dividers on the vertical axis have a distance of 20 nm from each other. It is clear that the sample 38 is caused to vibrate by the light signal, wherein the amplitude of the deflection A at the central measurement point 40B is somewhat larger than at the more outlying measurement points 40A, 40C. The vibration subsides within a period of less than 10 ms.

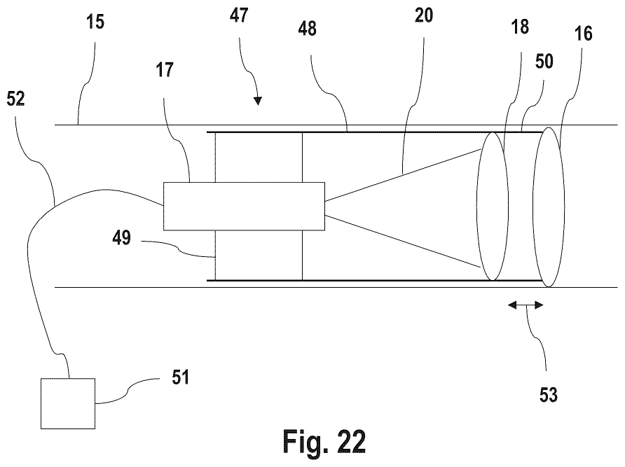

FIG. 22 shows an embodiment in which the optomechanical transducer 18 is a component of a hearing device 47. The hearing device 47 comprises a frame 48 which is inserted into the auditory canal 15 and carries the optomechanical transducer 18. The frame 48 comprises a front annular sleeve 50 which is supported on the eardrum 16 and defines the distance 53 between the eardrum 16 and the optomechanical transducer 18. Enclosed between the optomechanical transducer 18, the eardrum 16 and the annular sleeve 50 is an air volume, via which the optomechanical transducer 18 and the eardrum 16 are coupled to each other, such that vibrations from the optomechanical transducer 18 can be transferred to the eardrum 16.

The frame 48 further carries the signal generator 17, from which the light signal 20 propagates in the direction of the optomechanical transducer 18. The signal generator 17 is connected to the frame 48 via a plurality of struts 49. Air exchange from the auditory canal 15 in the direction of the optomechanical transducer 18 is possible through the clearance between the struts 49. The light source 51 is a structural unit which is separate from the signal generator 17 and can be arranged, for example, behind the auricle of the user. The light signal emitted by the light source 51 is transmitted to the signal generator 17 via a light guide 52. The hearing device 47 can be designed in such a way that it can be inserted by the user themself into their own auditory canal.

What is claimed:

1. A hearing excitation system for an eardrum (16), comprising a signal generator (17) and an optomechanical transducer (18) for exciting vibrations of the eardrum (16), wherein the signal generator (17) is designed to emit a light signal (20), such that the light signal (20) hits the optomechanical transducer (18) and the light signal (20) triggers thermal deformation in the optomechanical transducer (18), and wherein the thermal deformation causes a change in the curvature of the optomechanical transducer (18), as a result of which a surface portion (30, 31) of the optomechanical transducer (18) is deflected.

2. The hearing excitation system of claim 1, wherein the optomechanical transducer (18) is a prefabricated component configured to be arranged on the eardrum (16) of a supported ear.

3. The hearing excitation system of claim 2, wherein a coupling substance (26) is arranged between the optomechanical transducer (18) and the eardrum (16) of the supported ear.

4. The hearing excitation system of in claim 3, wherein the coupling substance (26) forms an adhesion layer.

5. The hearing excitation system of claim 1, wherein the optomechanical transducer (18) is arranged at a distance from the eardrum (16) and is coupled to the eardrum (16) by an air volume enclosed between the optomechanical transducer (18) and the eardrum (16).

6. The hearing excitation system of claim 5, wherein the optomechanical transducer (18) is air-permeable.

7. The hearing excitation system of claim 5, wherein the optomechanical transducer (18) is a component of a hearing device which comprises the signal generator (17) and the optomechanical transducer (18), which are permanently connected to each other as a unit.

8. The hearing excitation system of claim 1, wherein the optomechanical transducer (18) is a structure applied to the eardrum (16) as a coating.

9. The hearing excitation system of claim 1, wherein a contour of the optomechanical transducer (18) is largest in an X-Y plane, and wherein the optomechanical transducer (18) is deflected in a Z direction orthogonal thereto.

10. The hearing excitation system of claim 1, wherein the optomechanical transducer (18) has a shape pre-curved in the direction of the deflection.

11. The hearing excitation system of claim 1, wherein the optomechanical transducer (18) has a shape adapted to the topography of the eardrum (16).

12. The hearing excitation system of claim 1, wherein the signal generator (17) is provided with a passage channel (25).

13. The hearing excitation system of claim 1, wherein the signal generator (17) is configured such that the light signal (20) is applied to an area proportion of at least 20% of a front of the optomechanical transducer (18).

14. The hearing excitation system of claim 1, wherein the optomechanical transducer (18) is constructed from a plurality of materials, wherein a first material has a different coefficient of thermal expansion and/or a different light absorption coefficient and/or a different thermal conductivity and/or a different thermal capacity and/or a different mechanical stiffness than a second material.

15. A method for operating a hearing excitation system, in which a light signal (20) is directed to an optomechanical transducer (18) coupled to an eardrum (16), such that the light signal (20) triggers thermal deformation in the optomechanical transducer (18), wherein the thermal deformation causes a change in the curvature of the optomechanical transducer (18), as a result of which a surface portion (30, 31) of the optomechanical transducer (18) is deflected, and wherein a vibration of the eardrum (16) is excited by the deflection.
